(19) United States
(12) Patent Application Publication
(10) Pub. No.: US 2016/0054349 A1
(43) Pub. Date: Feb. 25, 2016

(54) WHISKER SENSOR DEVICE, METHOD OR MANUFACTURING THE SAME, AND COMPUTER METHOD, SYSTEM AND SOFTWARE FOR THE SAME

(71) Applicant: GENMARK AUTOMATION, INC., Milpitas, CA (US)

(72) Inventor: Bernhard Wolfgang STONAS, Hayward, CA (US)

(21) Appl. No.: 14/467,515

(22) Filed: Aug. 25, 2014

(51) Int. Cl. G01P 5/02

(52) U.S. Cl. CPC G01P 5/02

(57) ABSTRACT

A sensor device for measuring a flow of a fluid. The sensor device can have a support structure and a sensing structure. The support structure can have an elongated shape; can be flexible; can comprise steel, tungsten, carbon nanomaterial, polymer or plastic; can have multiple sides with sensing structures on each side; and can have a rectangular or square cross-section. A plurality of the sensor devices can be adapted for use on a surface of a vehicle or a microelectronic device. A plurality of sensing structures can be provided in any suitable configuration on the support structure. The sensor device can have any suitable shape, preferably similar to a flexible whisker. The sensing structure can be formed using a semiconductor etching method. Also, a method for manufacturing the sensor device and a computer method, system and software related to the sensor device are described.

### TECHNICAL FIELD

The present invention relates generally to sensors, and more particularly to sensors that detect the flow rate and direction of a fluid or gas; sensors for use in chemical reaction chambers; sensors that detect a thickness of a boundary layer if a flow of fluid or gas is laminar; and the like.

Sensors with flexible whisker elements are very useful for detecting contact, as well as for measuring fluid or air flow and direction. Just like the whiskers of an animal, whisker sensing elements can greatly increase the sensitivity of a sensor. Typically, a sensor comprises a long and flexible cantilever beam that bends in response to fluid or air flow, or when in contact with an object; the bending is then measured. Just like their animal counterparts, multiple whisker sensors can be used in arrays to provide accurate measurements of air or fluid flow over a surface, or to detect contact at any location along a surface.

Existing whisker sensors typically comprise a whisker element and a base region that measures the deflection of the whisker. The deflection of the whisker can be measured in only one direction or in two orthogonal directions. The measurement can be done by optical sensors, magnetic sensors, capacitive coupling, piezo-electric sensors, electric dial gauges, or strain gauges mounted at the base of the whisker.

One problem with existing prior art is that the deflection of the whisker is typically measured only at one point along its length. While this works for a sensor whose only function is to detect contact, it is more problematic for a sensor that is used to measure fluid flow. Flow rates in the boundary layer can be very different from the flow rates further away from the surface; the fluid velocity near the tip of the sensor can be very different from the fluid velocity near the base. A need exists to measure the exact curvature of the whisker all along its length rather than, as in the prior art, measuring just the curvature at the base or just the deflection of the tip.

Another problem with existing prior art is that while strain gauges are typically the most inexpensive and simplest way to measure whisker deflection, attaching them to the whisker is not easy or inexpensive. Typically, in the prior art, the strain gauges are mounted to the base of the whisker, which usually involves adhesives or soldering or other expensive procedures.

A need therefore exists for a less expensive, simpler, and temperature independent whisker sensor and method of manufacture thereof.

### SUMMARY OF THE INVENTION

One object of the present invention is to provide a whisker sensor that can detect fluid or gas motion in two orthogonal directions.

Another object of the present invention is to provide an inexpensive and simple method of manufacturing a whisker sensor.

Another object of the present invention is to provide a whisker sensor whose flexing can be measured at multiple points along its length.

Another object of the present invention is to provide a whisker sensor that is temperature independent and scalable.

Another object of the present invention is to provide a whisker sensor array to measure the aerodynamic properties of a vehicle and to change the aerodynamic properties of the vehicle based on data given by the whisker sensor.

In one embodiment of the present invention, a whisker sensor comprises a flexible cantilever whisker with a rectangular cross-section. Strain gauges are attached to the whisker on at least two orthogonal sides of the rectangular cross-section to measure flexing of the whisker. The strain gauges can be attached at any point or multiple points along the length of the whisker.

In another embodiment of the present invention, strain gauges are attached on all four sides of the whisker to measure flexing of the whisker.

In another embodiment of the present invention, a method of manufacturing of a whisker sensor comprises manufacturing a metal whisker with a rectangular cross section; depositing a layer of silicon oxide or other oxide along its length; and etching a strain gauge on the oxide layer on at least one side of the whisker.

The whisker sensor of the present invention can be used singly or in an array of sensors.

A method of using the whisker sensor of the present invention comprises mounting an array of whisker sensors on the surface of an object to measure its aerodynamic properties, and dynamically changing the shape of the object in real time in response to the data provided by the whisker sensors.

In one aspect, provided herein is a whisker sensor comprising a flexible cantilever whisker with a rectangular cross-section; and at least one strain gauge mounted on the surface of the whisker.

In one embodiment of this aspect, the whisker sensor comprises at least one strain gauge mounted on each side of the whisker.

In another embodiment of this aspect, the at least one strain gauge is mounted at a location on the whisker that is not close to the base of the whisker.

In another embodiment of this aspect, the whisker sensor comprises at least one strain gauge mounted at a location on the whisker that is close to the base of the whisker and at least one strain gauge mounted at a location on the whisker that is not close to the base of the whisker.

In another embodiment of this aspect, the cross-section of the whisker is square.

In another embodiment of this aspect, the whisker is made of steel.

In another embodiment of this aspect, the whisker is made of tungsten.

In another embodiment of this aspect, the whisker sensor is used to measure flow characteristics.

In another embodiment of this aspect, a pressure sensor and a thermometer are used with the whisker sensor to develop the flow characteristics for a chemical reaction.

In another embodiment of this aspect, the whisker sensor is used to develop the flow characteristics for a drag coefficient of an area.

In another embodiment of this aspect, the whisker sensor is used to develop the flow characteristics for a drag coefficient of a physical shape.

In another aspect, provided herein is a method of manufacturing a whisker sensor comprises manufacturing a whisker with a rectangular cross-section; depositing an oxide layer on the surface of the whisker; depositing a metal on the oxide layer to make a strain gauge on at least one side of the whisker; and depositing an insulator layer on at least one side of the whisker.

In one embodiment of this aspect, the metal is copper.

In another embodiment of this aspect, the metal is beryllium.

In another embodiment of this aspect, the strain gauges are deposited on four sides of the whisker.

In another embodiment of this aspect, the strain gauges are deposited on multiple locations along the length of the whisker.

In another embodiment of this aspect, the whisker sensor is used to measure flow characteristics.

In another embodiment of this aspect, a pressure sensor and a thermometer are used with the whisker sensor to develop the flow characteristics for a chemical reaction.

In another embodiment of this aspect, the whisker sensor is used to develop the flow characteristics for a drag coefficient of an area.

In another embodiment of this aspect, the whisker sensor is used to develop the flow characteristics for a drag coefficient of a physical shape.

In another aspect, provided herein is a computer implemented method for measuring a flow of a fluid or a gas, comprising on a device having one or more processors and a memory storing one or more programs for execution by the one or more processors, the one or more programs including instructions for receiving a first signal from a first portion of a whisker sensor and a second signal from a second portion of the whisker sensor; and analyzing the first signal and the second signal to measure laminar flow and differential flow along a length of the whisker sensor, where the whisker sensor comprises a flexible cantilever whisker with a rectangular cross-section; and at least one strain gauge mounted on the surface of the whisker.

In another aspect, provided herein is a computer system for measuring a flow of a fluid or a gas, comprising one or more processors and memory to store one or more programs, the one or more programs comprising instructions for receiving a first signal from a first portion of a whisker sensor and a second signal from a second portion of the whisker sensor; and analyzing the first signal and the second signal to measure laminar flow and differential flow along a length of the whisker sensor, where the whisker sensor comprises a flexible cantilever whisker with a rectangular cross-section; and at least one strain gauge mounted on the surface of the whisker.

In another aspect, provided herein is a non-transitory computer-readable storage medium storing one or more programs for measuring a flow of a fluid or a gas, the one or more programs for execution by one or more processors of a computer system, the one or more programs comprising instructions for receiving a first signal from a first portion of a whisker sensor and a second signal from a second portion of the whisker sensor; and analyzing the first signal and the second signal to measure laminar flow and differential flow along a length of the whisker sensor, where the whisker sensor comprises a flexible cantilever whisker with a rectangular cross-section; and at least one strain gauge mounted on the surface of the whisker.

In another aspect, provided herein is a sensor device for measuring a flow of a fluid, the sensor device comprising a support structure; and a sensing structure.

In one embodiment of this aspect, the support structure has an elongated shape.

In another embodiment of this aspect, the support structure is flexible.

In another embodiment of this aspect, at least one surface of the support structure is adapted to receive the sensing structure.

In another embodiment of this aspect, the support structure comprises at least one from the group consisting of steel, tungsten, a carbon nanomaterial, a polymer and a plastic.

In another embodiment of this aspect, a plurality of the sensor devices is adapted for use on a surface of a vehicle.

In another embodiment of this aspect, a plurality of the sensor devices is adapted for use on a surface of a microelectronic device.

In another embodiment of this aspect, the support structure comprises multiple sides and the sensing structure is provided on each of the multiple sides.

In another embodiment of this aspect, the support structure has a rectangular or square cross-section, and each of the four sides of the support structure comprises the sensing structure.

In another embodiment of this aspect, a first sensing structure is provided at a first location along a length of the support structure, where a second sensing structure is provided at a second location along the length of the support structure, where a third sensing structure is provided at a third location along the length of the support structure, where a first distance between a base of the support structure and the first location is approximately the same as a second distance between the first location and the second location, and where a third distance is approximately the same as the first and second distances.

In another embodiment of this aspect, a width, a depth and a length of the sensor device is provided in a ratio of about 1:1:25, respectively.

In another embodiment of this aspect, the sensor device is adapted for use in a range of typical flow rates, and where the sensor device is adapted to deflect in a manner that is measurable within the range of typical flow rates.

In another embodiment of this aspect, the sensing structure is formed by a semiconductor etching method.

In another embodiment of this aspect, the sensing structure comprises a first layer deposited over the support structure and a second layer deposited over the support structure.

In another embodiment of this aspect, the first layer comprises one from the group consisting of oxide, nitride, silicon oxide, silicon nitride, silicon carbon nitride and nitrided oxide.

In another embodiment of this aspect, the second layer comprises metal.

In another embodiment of this aspect, the alloy is a copper/nickel alloy.

In another embodiment of this aspect, the first layer completely covers the support structure and where the second layer partially covers the first layer.

In another embodiment of this aspect, the sensing structure further comprises a third layer deposited over the support structure.

In another embodiment of this aspect, the third layer is an insulator layer.

In another embodiment of this aspect, a first portion of the third layer is formed over and in contact with the first layer and a second portion of the third layer is formed over and in contact with the second layer.

In another embodiment of this aspect, each of plurality of sensor devices is mounted on the surface of the vehicle by one selected from the group consisting of soldering, insertion of the sensor device into a corresponding hole in the surface of the vehicle, and spot-welding.

In another embodiment of this aspect, an aerodynamic profile of the vehicle is modified in real time to improve an aerodynamic efficiency of the vehicle in response to signals received from the plurality of sensor devices.

In another embodiment of this aspect, a first sensing structure is provided at a first location along a length of the support structure, where a second sensing structure is provided at a second location along the length of the support structure, and where the first and second sensing structures are adapted to measure and detect a thickness of a boundary layer associated with a chemical reaction.

In another embodiment of this aspect, a first sensing structure is provided at a first location along a length of the support structure, where a second sensing structure is provided at a second location along the length of the support structure, and where the first and second sensing structures are adapted to measure and detect a laminar flow of the fluid at a first location along a length of the sensor device and a differential flow of the fluid at a second location along the length of the sensor device.

In another embodiment of this aspect, a first sensor device has a first aspect ratio and is adapted to vibrate in response to a wave at a first frequency, a second sensor device has a second aspect ratio and is adapted to vibrate in response to a wave at a second frequency.

In another embodiment of this aspect, the sensor device is adapted to function in a manner similar to that of a human cochlea.

In another aspect, provided herein is a method of manufacturing a sensor device for measuring a flow of a fluid, the method comprising forming a support structure; and forming a sensing structure.

In another aspect, provided herein is a computer implemented method for measuring a flow of a fluid, comprising on a device having one or more processors and a memory storing one or more programs for execution by the one or more processors, the one or more programs including instructions for receiving a first signal from a first portion of a sensor device and a second signal from a second portion of the sensor device; and analyzing the first signal and the second signal, where the sensor device comprises a support structure; and a sensing structure.

In another aspect, provided herein is a computer system for measuring a flow of a fluid, comprising one or more processors and memory to store one or more programs, the one or more programs comprising instructions for receiving a first signal from a first portion of a sensor device and a second signal from a second portion of the sensor device; and analyzing the first signal and the second signal to measure laminar flow and differential flow along a length of the sensor device, where the sensor device comprises a support structure; and a sensing structure.

In another aspect, provided herein is a non-transitory computer-readable storage medium storing one or more programs for measuring a flow of a fluid, the one or more programs for execution by one or more processors of a computer system, the one or more programs comprising instructions for receiving a first signal from a first portion of a sensor device and a second signal from a second portion of the sensor device; and analyzing the first signal and the second signal, where the sensor device comprises a support structure; and a sensing structure.

### BRIEF DESCRIPTION OF THE DRAWINGS

The accompanying drawings, which are incorporated into this specification, illustrate one or more exemplary embodiments of the inventions disclosed herein and, together with the detailed description, serve to explain the principles and exemplary implementations of these inventions. One of skill in the art will understand that the drawings are illustrative only, and that what is depicted therein may be adapted based on the text of the specification and the spirit and scope of the teachings herein.

In the drawings, where like reference numerals refer to like reference in the specification:

FIG. 1 illustrates one embodiment of the present invention;

FIG. 2 illustrates a cross-sectional view of one embodiment of the present invention;

FIG. 3 illustrates an array of sensors according to one embodiment of the present invention; and

FIG. 4 illustrates a computer device or system for use with the whisker sensor of the present invention.

### DETAILED DESCRIPTION

It should be understood that this invention is not limited to the particular methodology, protocols, etc., described herein and as such may vary. The terminology used herein is for the purpose of describing particular embodiments only, and is not intended to limit the scope of the present invention, which is defined solely by the claims.

As used herein and in the claims, the singular forms include the plural reference and vice versa unless the context clearly indicates otherwise. Other than in the operating examples, or where otherwise indicated, all numbers expressing quantities used herein should be understood as modified in all instances by the term “about.”

All publications identified are expressly incorporated herein by reference for the purpose of describing and disclosing, for example, the methodologies described in such publications that might be used in connection with the present invention. These publications are provided solely for their disclosure prior to the filing date of the present application. Nothing in this regard should be construed as an admission that the inventors are not entitled to antedate such disclosure by virtue of prior invention or for any other reason. All statements as to the date or representation as to the contents of these documents is based on the information available to the applicants and does not constitute any admission as to the correctness of the dates or contents of these documents.

Unless defined otherwise, all technical and scientific terms used herein have the same meaning as those commonly understood to one of ordinary skill in the art to which this invention pertains. Although any known methods, devices, and materials may be used in the practice or testing of the invention, the methods, devices, and materials in this regard are described herein.

Some Selected Definitions

Unless stated otherwise, or implicit from context, the following terms and phrases include the meanings provided below. Unless explicitly stated otherwise, or apparent from context, the terms and phrases below do not exclude the meaning that the term or phrase has acquired in the art to which it pertains. The definitions are provided to aid in describing particular embodiments of the aspects described herein, and are not intended to limit the claimed invention, because the scope of the invention is limited only by the claims. Further, unless otherwise required by context, singular terms shall include pluralities and plural terms shall include the singular.

As used herein the term “comprising” or “comprises” is used in reference to compositions, methods, and respective component(s) thereof, that are essential to the invention, yet open to the inclusion of unspecified elements, whether essential or not.

As used herein the term “consisting essentially of” refers to those elements required for a given embodiment. The term permits the presence of additional elements that do not materially affect the basic and novel or functional characteristic(s) of that embodiment of the invention.

The term “consisting of” refers to compositions, methods, and respective components thereof as described herein, which are exclusive of any element not recited in that description of the embodiment.

Other than in the operating examples, or where otherwise indicated, all numbers expressing quantities used herein should be understood as modified in all instances by the term “about.” The term “about” when used in connection with percentages may mean ±1%.

In embodiments of the disclosure, terms such as “about,” “approximately,” and “substantially” can include traditional rounding according to significant figures of the numerical value.

The singular terms “a,” “an,” and “the” include plural referents unless context clearly indicates otherwise. Similarly, the word “or” is intended to include “and” unless the context clearly indicates otherwise. Thus for example, references to “the method” includes one or more methods, and/or steps of the type described herein and/or which will become apparent to those persons skilled in the art upon reading this disclosure and so forth.

Although methods and materials similar or equivalent to those described herein can be used in the practice or testing of this disclosure, suitable methods and materials are described below. The term “comprises” means “includes.” The abbreviation, “e.g.” is derived from the Latin exempli gratia, and is used herein to indicate a non-limiting example. Thus, the abbreviation “e.g.” is synonymous with the term “for example.”

In embodiments of the disclosure, terms such as “whisker,” “hair,” “whisker sensor,” “hair sensor” and “sensor” can be used interchangeably.

To the extent not already indicated, it will be understood by those of ordinary skill in the art that any one of the various embodiments herein described and illustrated may be further modified to incorporate features shown in any of the other embodiments disclosed herein.

The following examples illustrate some embodiments and aspects of the invention. It will be apparent to those skilled in the relevant art that various modifications, additions, substitutions, and the like can be performed without altering the spirit or scope of the invention, and such modifications and variations are encompassed within the scope of the invention as defined in the claims which follow. The following examples do not in any way limit the invention.

Although some of various drawings illustrate a number of logical stages in a particular order, stages which are not order dependent can be reordered and other stages can be combined or broken out. Alternative orderings and groupings, whether described above or not, can be appropriate or obvious to those of ordinary skill in the art of computer science. Moreover, it should be recognized that the stages could be implemented in hardware, firmware, software or any combination thereof.

The foregoing description, for purpose of explanation, has been described with reference to specific embodiments. However, the illustrative discussions above are not intended to be exhaustive or to be limiting to the precise forms disclosed. Many modifications and variations are possible in view of the above teachings. The embodiments were chosen and described in order to best explain the principles of the aspects and its practical applications, to thereby enable others skilled in the art to best utilize the aspects and various embodiments with various modifications as are suited to the particular use contemplated.

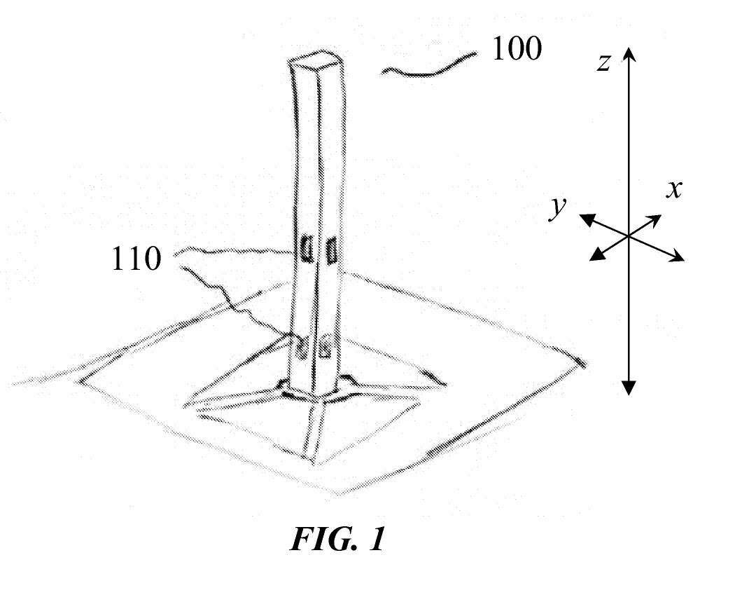

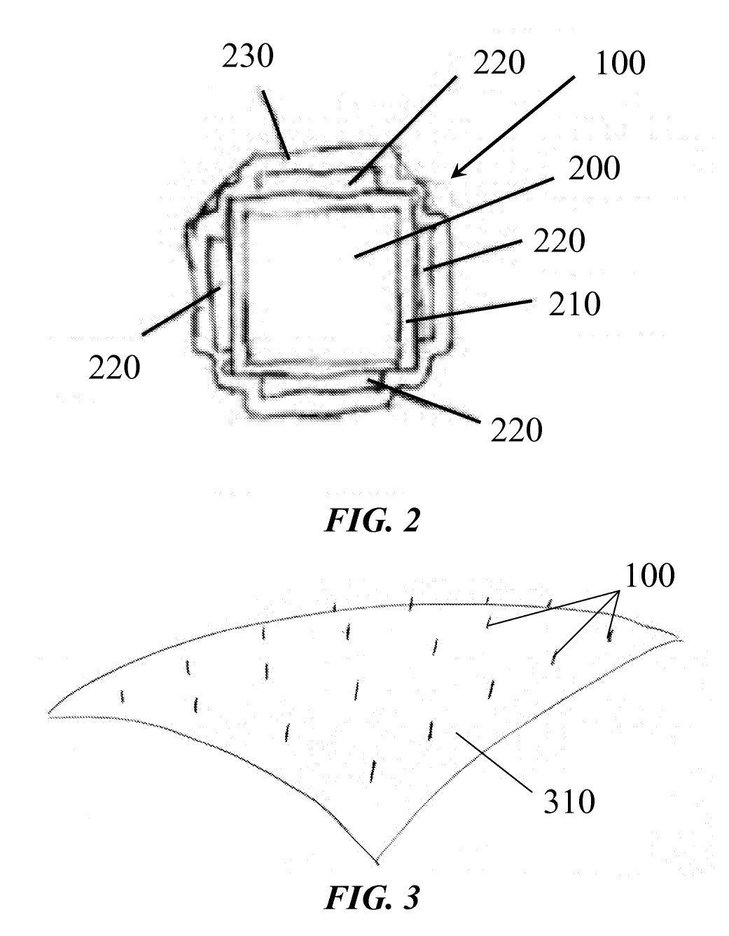

As shown in FIG. 1, one embodiment of the present invention comprises an elongated whisker 100 with a rectangular cross-section (see, FIG. 2 for an exemplary cross-section of the whisker). The whisker 100 can be made of a flexible material that can withstand repeated bending in any direction. Preferably, the whisker is made of steel or tungsten (for high temperature applications), but any other metal, plastic, or other material can also be used, as long as it is flexible and strong enough to withstand repeated bending. Dimensions for the whisker 100 are flexible to suit the application. The whisker 100 is scalable; for example, a macro scale whisker can be used for aeronautical applications such as a wing of an airplane. Also, a micro scale whisker can be used for microelectronic applications and can include an inflatable bladder. The whisker 100 can be dimensioned to be suitable for a given flow scale and a given flow force. The whisker 100 can be sized to have x, y and z dimensions on the order of millimeters (mm), micrometers (μm or micron), nanometers (nm) or Angstroms (Å). For example, known presently available semiconductor etching methods enable microscale and nanoscale etching, particularly for micro and nanocircuitry. The entire whisker can be manufactured using semiconductor deposition and etching methods. Alternately, a two or more step process can be used including a first method of forming a base 200 of the whisker 100, and a second method of forming components such as strain gauges 110. For example, the first method of forming the base 200 of the whisker 100 can comprise any suitable method of forming a long thin core having circular or rectangular cross sections. For example, steel or tungsten, carbon nanomaterials, polymers, plastics, can be used for the base 200. For example, the second method of forming the strain gauges 110 of the whisker 100 can comprise any suitable method of forming strain gauges including semiconductor style deposition methods. 3D printing and other known manufacturing methods can be employed in some embodiments.

Strain gauges 110 are preferably mounted on all four sides of the whisker 100. In one embodiment, groups of four strain gauges are placed at multiple points along the length of the whisker. For example, three groups of strain gauges can be evenly distributed at three locations along the length of the whisker corresponding with about 25%, about 50% and about 75% of the length of the whisker 100. In other words, the first, second and third groups of strain gauges 110 can be located at or near the base, middle and tip of the whisker 100, respectively. This improves the accuracy of the measurement by making it possible to measure the curvature of the whisker at multiple points along its length, thus making it possible to estimate the flow profile and boundary flows more accurately.

The whisker 100 may be formed having any suitable x, y and z dimensions, the dimensions depending on material selection, fluid dynamic pressure and fluid flow rate for the desired operating conditions. For example, for an application of the whisker 100 in an environment producing 60 mph air flow at atmospheric pressure, exemplary dimensions of the whisker 100 can be on the order of about x=2 mm, y=2 mm and z=50 mm, i.e., a ratio of x:y:z of 1:1:25 although other suitable ratios can be used.

Preferably, the dimensions of the whisker are such that the typical flow rate it is likely to encounter produces a deflection that is easy to measure.

In one embodiment, the strain gauges are etched onto the whisker by semiconductor etching methods. FIG. 2 shows a cross-sectional view of a whisker manufactured in that way. First, a whisker 100 with a base 200 having, for example, a rectangular cross-section is manufactured. A thin layer of silicon oxide or other oxide 210 used in semiconductor manufacturing is deposited on the surface of the whisker; the oxide layer 210 is thin enough to be flexible so that it does not impede flexing of the whisker. At least one copper/nickel alloy strain gauge 220 can then be deposited on top of the oxide layer 210 using semiconductor manufacturing methods, and covered with an insulator layer 230. This is significantly less expensive and simpler than attaching strain gauges to the whisker by other means, and makes it possible to attach multiple strain gauges to a whisker at any point along its length. Paralyne can be used as a boundary layer. Silicon oxide, silicon nitride, silicon carbon nitride, nitrided oxides and the like can also be used.

A whisker, such as the elongated whisker 100 shown in FIG. 1, is mounted to a surface 310 by soldering, by insertion into a hole in the surface, by spot-welding, or any other mounting methods known in the art. Multiple whiskers may be used, as shown in FIG. 3. Such arrays of multiple whiskers may be used to measure the aerodynamic properties of a surface or an object. For example, the whiskers can be mounted on the surface of a car to measure its aerodynamic properties. Because these whiskers are simple and inexpensive to make and install, they may be permanently mounted on the surface of a car or other object, and may continuously provide data regarding its aerodynamic properties. The data may then be used to dynamically change the shape of the car or other object in real time to improve its aerodynamic efficiency. In some embodiments, a processor (not shown) can be provided at the base of the whisker that detects a first signal generated by motion of the whisker in a first direction and a second signal generated by motion of the whisker in a second direction.

Composition of the Hair.

The hair sensor can comprise a four sided hair with a rectangular or square cross-section. A metal substrate can be used. A layer of insulation can be deposited on the metal substrate and four resistive elements can be deposited on the layer of insulation. One resistive element can be located on each side of the hair. The resistive elements can then be connected to the metal layer on one end and to a wire on the other. The four wires can then be connected to instrument operational amplifiers so that a signal of magnitude can be derived.

How the Hair Works. Nuances of the Hair.

This hair can be adapted to deflect as pressure of air or fluid moving past the hair either increases or decreases. By having the resistive elements on both sides of the hair, the sensitivity is both increased due to air or fluid flow as well as decreased due to temperature fluctuations. For temperature changes, the resistances of opposing elements increase equally, thus canceling each other out. Conversely, the air or fluid flow will elongate one of the resistive elements and decrease the length of the other on the opposite side. Because of the geometry of the cross section, the sensor will allow air or fluid flow to be measured if air or fluid is coming from various angles. Also, as the hair is relatively thin with respect to its length, it allows for measurement of turbulence of the wind as well. For example, as noted above, a ratio of x:y:z of 1:1:25 can be used. Turbulence can be measured using the instrument operational amplifier described above. In some embodiments, for example, when turbulent flow is present, the instrument operational amplifier can provide a sinusoidal wave having a frequency and a period of oscillation, which can be used to determine a magnitude or an amplitude.

The placement of the resistive element can provide information regarding a magnitude of flow as well as what kind of flow is going over the hair. The flow characteristics are indicative of how much air or fluid flow is going over the surface but also a thickness of a boundary layer of dead air or fluid that is at the surface of the sensor. The thinner this boundary layer is the lower the impact various surface modifications will be to the air or fluid flow. Also, if one is trying to get rid of heat, this boundary layer acts as an insulating layer. For chemical reactions that are happening on a surface location, this surface flow characteristic becomes very important.

For example, in some embodiments, where three groups of strain gauges are evenly distributed at three locations along the length of the whisker corresponding with about 25%, about 50% and about 75% of the length of the whisker 100, the gauges near the middle and tip of the whisker can measure differential flow, and the gauge near the base of the whisker can measure laminar flow.

The hair can both measure the flow as well as determine the flow profile of the surface. Both are applicable for various applications.

Standing Waves of the Hair.

Since the hair can act as a tuning fork depending on the aspect ratio of the width to the length as well as the length of the hair, the hair can be used as a listening device for certain frequencies. For example, a variety of hair lengths can be assembled in a small space to create a listening device much like the human cochlea. In some embodiments, one frequency can correspond to one hair, a second frequency to another hair, and so on.

Creation of the Hair Sensor.

The hair sensor starts out with a square piece of substrate. The dimensions (for example, x=2 mm, y=2 mm and z=50 mm) of this piece are to be determined by both the application as well as the flow which the sensor will be exposed to. Onto the substrate a very thin (that is, on the order of microns or Angstroms) film of insulating material is deposited. This can be comprised of silicon oxide to plastic to a wide variety of materials. A hole is made through the insulating layer so that the next layer can have an electrical connection to the substrate. Next, a thin resistive layer is deposited onto the outside of the hair in a pattern which will give a high resistive-to-elongation ratio. A wire is bonded to the base of the hair so that the hair can transmit the resistive value to the instrument operational amplifier. An encapsulating layer is then layered on top of the resistive layer. This prevents issues with humidity as well as if the hair is put into a conductive fluid. The hair with the four wires coming off of the end of it is then inserted into a base material which contains the two instrument operational amplifiers, one for either direction. Then, a wire is connected from the back side to the center of the hair sensor so that the hair is powered. The instrument operational amplifiers then produce a signal for either direction back to a central sensor computer.

Use of Sensors in a Field.

The hair sensors give a value of flow and direction as well as boundary layer characteristics at that particular point but not at another point. To increase the measurement over the surface, multiple sensors can be placed on the surface. Combining this with pressure sensors and temperature sensors, various chemical chambers and process vessels can be mapped to detect issues on their surfaces.

Using the Sensing Data as Input into Surface Modifications.

When these sensors are provided on an outside surface of an object, they can optimize the surface of the object so that drag is decreased and so that a correct amount of drag lift or pressure is put onto that particular area of the surface to get a desired response that the aerodynamics or chemical reactions require. These can be achieved by dimpling (very similar to that of a golf ball) all the way up to use of spoilers and various large scale aerodynamic features to create lift in real time. The sensors give an object a way to sense the aerodynamic characteristics of the environment in a manner that is like that of an animal and the object can be adapted to act in response to this information according to a particular need.

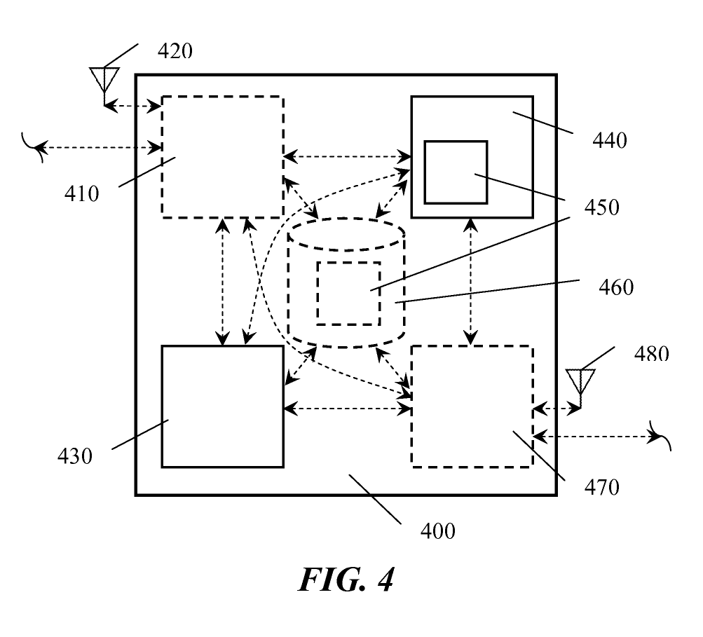

FIG. 4 depicts a computer device or system 400 comprising one or more processors 430 and a memory 440 storing one or more programs 450 for execution by the one or more processors 430.

In some embodiments, the device or computer system 400 can further comprise a non-transitory computer-readable storage medium 460 storing the one or more programs 450 for execution by the one or more processors 430 of the device or computer system 400.

In some embodiments, the device or computer system 400 can further comprise one or more input devices 410, which can be configured to send or receive information to or from any one from the group consisting of: an external device (not shown), the one or more processors 430, the memory 440, the non-transitory computer-readable storage medium 460, and one or more output devices 470. The one or more input devices 410 can be configured to wirelessly send or receive information to or from the external device via a means for wireless communication, such as an antenna 420, a transceiver (not shown) or the like.

In some embodiments, the device or computer system 400 can further comprise one or more output devices 470, which can be configured to send or receive information to or from any one from the group consisting of: an external device (not shown), the one or more input devices 410, the one or more processors 430, the memory 440, and the non-transitory computer-readable storage medium 460. The one or more output devices 470 can be configured to wirelessly send or receive information to or from the external device via a means for wireless communication, such as an antenna 480, a transceiver (not shown) or the like.

The device or computer system 400 can be programmed with software including instructions for receiving a first signal from a first portion of a whisker sensor and a second signal from a second portion of the whisker sensor; and analyzing the first signal and the second signal to measure laminar flow and differential flow along a length of the whisker sensor. Although two signals and two portions are described, any suitable number may be used.

Each of the above identified modules or programs corresponds to a set of instructions for performing a function described above. These modules and programs (i.e., sets of instructions) need not be implemented as separate software programs, procedures or modules, and thus various subsets of these modules may be combined or otherwise re-arranged in various embodiments. In some embodiments, memory may store a subset of the modules and data structures identified above. Furthermore, memory may store additional modules and data structures not described above.

The illustrated aspects of the disclosure may also be practiced in distributed computing environments where certain tasks are performed by remote processing devices that are linked through a communications network. In a distributed computing environment, program modules can be located in both local and remote memory storage devices.

Moreover, it is to be appreciated that various components described herein can include electrical circuit(s) that can include components and circuitry elements of suitable value in order to implement the embodiments of the subject innovation(s). Furthermore, it can be appreciated that many of the various components can be implemented on one or more integrated circuit (IC) chips. For example, in one embodiment, a set of components can be implemented in a single IC chip. In other embodiments, one or more of respective components are fabricated or implemented on separate IC chips.

What has been described above includes examples of the embodiments of the present invention. It is, of course, not possible to describe every conceivable combination of components or methodologies for purposes of describing the claimed subject matter, but it is to be appreciated that many further combinations and permutations of the subject innovation are possible. Accordingly, the claimed subject matter is intended to embrace all such alterations, modifications, and variations that fall within the spirit and scope of the appended claims. Moreover, the above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In particular and in regard to the various functions performed by the above described components, devices, circuits, systems and the like, the terms used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter. In this regard, it will also be recognized that the innovation includes a system as well as a computer-readable storage medium having computer-executable instructions for performing the acts and/or events of the various methods of the claimed subject matter.

The aforementioned systems/circuits/modules have been described with respect to interaction between several components/blocks. It can be appreciated that such systems/circuits and components/blocks can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but known by those of skill in the art.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” or the like are generally intended to refer to a computer-related entity, either hardware (e.g., a circuit), a combination of hardware and software, software, or an entity related to an operational machine with one or more specific functionalities. For example, a component may be, but is not limited to being, a process running on a processor (e.g., digital signal processor), a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers. Further, a “device” can come in the form of specially designed hardware; generalized hardware made specialized by the execution of software thereon that enables the hardware to perform specific function; software stored on a computer-readable medium; or a combination thereof.

Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Computing devices typically include a variety of media, which can include computer-readable storage media and/or communications media, in which these two terms are used herein differently from one another as follows. Computer-readable storage media can be any available storage media that can be accessed by the computer, is typically of a non-transitory nature, and can include both volatile and nonvolatile media, removable and non-removable media. By way of example, and not limitation, computer-readable storage media can be implemented in connection with any method or technology for storage of information such as computer-readable instructions, program modules, structured data, or unstructured data. Computer-readable storage media can include, but are not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or other tangible and/or non-transitory media which can be used to store desired information. Computer-readable storage media can be accessed by one or more local or remote computing devices, e.g., via access requests, queries or other data retrieval protocols, for a variety of operations with respect to the information stored by the medium.

On the other hand, communications media typically embody computer-readable instructions, data structures, program modules or other structured or unstructured data in a data signal that can be transitory such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

In view of the exemplary systems described above, methodologies that may be implemented in accordance with the described subject matter will be better appreciated with reference to the flowcharts of the various figures. For simplicity of explanation, the methodologies are depicted and described as a series of acts. However, acts in accordance with this disclosure can occur in various orders and/or concurrently, and with other acts not presented and described herein. Furthermore, not all illustrated acts may be required to implement the methodologies in accordance with the disclosed subject matter. In addition, those skilled in the art will understand and appreciate that the methodologies could alternatively be represented as a series of interrelated states via a state diagram or events. Additionally, it should be appreciated that the methodologies disclosed in this specification are capable of being stored on an article of manufacture to facilitate transporting and transferring such methodologies to computing devices. The term article of manufacture, as used herein, is intended to encompass a computer program accessible from any computer-readable device or storage media.

### BEST MODE

Embodiments of the best modes of the invention are set forth in FIGS. 1-3 and in the descriptions associated with the same.

### INDUSTRIAL APPLICABILITY

The present invention is applicable in the following industries: instrumentation, chemical sensors, physical sensors, aeronautics, aerospace, automotive, microelectronics, acoustics, and the like.

I/We claim:

1. A sensor device for measuring a flow of a fluid, the sensor device comprising:
a support structure; and
a sensing structure.

2. The sensor device of claim 1, wherein the support structure has an elongated shape.

3. The sensor device of claim 1, wherein the support structure is flexible.

4. The sensor device of claim 1, wherein at least one surface of the support structure is adapted to receive the sensing structure.

5. The sensor device of claim 1, wherein the support structure comprises at least one from the group consisting of steel, tungsten, a carbon nanomaterial, a polymer and a plastic.

6. The sensor device of claim 1, wherein a plurality of the sensor devices is adapted for use on a surface of a vehicle.

7. The sensor device of claim 1, wherein a plurality of the sensor devices is adapted for use on a surface of a microelectronic device.

8. The sensor device of claim 1, wherein the support structure comprises multiple sides and wherein the sensing structure is provided on each of the multiple sides.

9. The sensor device of claim 1, wherein the support structure has a rectangular or square cross-section, and wherein each of the four sides of the support structure comprises the sensing structure.

10. The sensor device of claim 1, wherein a first sensing structure is provided at a first location along a length of the support structure, wherein a second sensing structure is provided at a second location along the length of the support structure, wherein a third sensing structure is provided at a third location along the length of the support structure, wherein a first distance between a base of the support structure and the first location is approximately the same as a second distance between the first location and the second location, and wherein a third distance is approximately the same as the first and second distances.

11. The sensor device of claim 1, wherein a width, a depth and a length of the sensor device is provided in a ratio of about 1:1:25, respectively.

12. The sensor device of claim 1, wherein the sensor device is adapted for use in a range of typical flow rates, and wherein the sensor device is adapted to deflect in a manner that is measurable within the range of typical flow rates.

13. The sensor device of claim 1, wherein the sensing structure is formed by a semiconductor etching method.

14. The sensor device of claim 6, wherein an aerodynamic profile of the vehicle is modified in real time to improve an aerodynamic efficiency of the vehicle in response to signals received from the plurality of sensor devices.

15. The sensor device of claim 1, wherein a first sensing structure is provided at a first location along a length of the support structure, wherein a second sensing structure is provided at a second location along the length of the support structure, and wherein the first and second sensing structures are adapted to measure and detect a thickness of a boundary layer associated with a chemical reaction.

16. The sensor device of claim 1, wherein a first sensing structure is provided at a first location along a length of the support structure, wherein a second sensing structure is provided at a second location along the length of the support structure, and wherein the first and second sensing structures are adapted to measure and detect a laminar flow of the fluid at a first location along a length of the sensor device and a differential flow of the fluid at a second location along the length of the sensor device.

17. The sensor device of claim 1, wherein a first sensor device has a first aspect ratio and is adapted to vibrate in response to a wave at a first frequency, wherein a second sensor device has a second aspect ratio and is adapted to vibrate in response to a wave at a second frequency.

18. The sensor device of claim 1, wherein the sensor device is adapted to function in a manner similar to that of a human cochlea.

19. A method of manufacturing a sensor device for measuring a flow of a fluid, the method comprising:
forming a support structure; and
forming a sensing structure.

20. A computer implemented method for measuring a flow of a fluid, comprising:
on a device having one or more processors and a memory storing one or more programs for execution by the one or more processors, the one or more programs including instructions for:
receiving a first signal from a first portion of a sensor device and a second signal from a second portion of the sensor device; and
analyzing the first signal and the second signal,
wherein the sensor device comprises:
a support structure; and
a sensing structure.
